(19) United States
(12) Patent Application Publication
(10) Pub. No.: US 2008/0263935 A1
(43) Pub. Date: Oct. 30, 2008

(54) VIBRATING FISHING LURE

(76) Inventors: Rudy S. Albrecht, St. Charles, IL (US); Karl Franzen, Clinton, IA (US)

Correspondence Address: CLAUSEN MILLER, P.C, SUITE 1600, 10S. LASALLE STREET, CHICAGO, IL, 60603, US

(21) Appl. No.: 11/741,139

(22) Filed: Apr. 27, 2007

(51) Int. Cl. A01K 85/10; A01K 85/00

(52) U.S. Cl. 43/42.13; 43/42.49; 43/42.47

(57) ABSTRACT

A fishing lure comprising a substantially V-shaped wire having an eye loop at its apex and first and second arms extending from the eye loop. A jig head having a fishhook projecting therefrom is attached to the end of one arm. A spinner blade is attached to the end of the other arm. A second blade is attached to the eye loop to impart a vibrating motion to the lure.

### BACKGROUND

1. Field of the Invention

This patent relates to a fishing lure. More particularly, this patent relates to a fishing lure having a blade that imparts a vibrational effect to the lure to entice fish.

2. Description of the Related Art

Numerous fishing lures have been developed over the years in attempts to attract, and thus catch, more game fish. Some of the more popular lure styles include jigs, jerk baits, crank baits, chatter baits and spinner baits.

A jig is a type of fishing lure comprising a lead sinker or head with a hook extending out of it. The fishing line attaches directly to an eyelet on the head. Jigs often have a plastic or rubber body attached to the head and shaped to resemble a frog, fish, lizard, bug or other live bait. It is common to place on the hook a plastic trailer or other type of trailer to simulate live bait. Jigs come in a variety of weights, from ⅛ of an ounce or less to 1.5 ounces or more.

A jerk bait is a lure having a hard, slender body and a lip to pull the lure underwater. Two or more small treble hooks extend from the body. Unlike chatter baits and spinner baits, the fisherman imparts most of the motion to the lure by playing with the line so that the lure moves erratically in the water.

A chatter bait is a type of lure that combines a jig with a blade attached near the front of the jighead to impart a vibrating movement. The line attaches to a snap located at the front end of the blade which sits in front of the jighead.

A spinner bait is a lure having a bent metal wire with a lead head and hook attached to one wire arm and a blade attached to the other wire arm that spins to entice game fish. Numerous spinner bait lures are described in the patent literature, including Stanczyk U.S. Pat. No. 4,671,007; Fuller U.S. Pat. No. 5,381,621; Boullt et al. U.S. Pat. No. 5,605,004; Taibi U.S. Pat. No. 5,974,723; Mathews, Jr. et al. U.S. Pat. No. 6,796,080; Cox U.S. Pat. No. 6,840,001; Eubanks U.S. Pat. No. 6,880,287; Trantham U.S. Pat. No. 6,918,204; Fasnacht U.S. Pat. No. 7,121,039; and Roemer U.S. Patent Application Publication No. 2003/015327.

While these and other lures may be suitable for their intended purpose, none provides the combined benefits of a chatter bait lure and a spinner bait lure.

Thus it is an object of the present invention to provide a new type of lure having a spinning blade and a second blade that imparts vibrational movement to the lure.

Yet another object of the invention is to provide a lure having a blade that imparts vibrational movement to the lure but not the fishing line.

Further and additional objects will appear from the description, accompanying drawings, and appended claims.

### SUMMARY OF THE INVENTION

The present invention is a novel fishing lure combining the advantages of a chatter bait lure and a spinner bait lure. The lure comprises a substantially V-shaped wire having an eye loop at its apex and first and second arms extending from the eye loop. A jig head having a fishhook projecting therefrom is attached to one arm. A spinner blade is attached to the second arm. Preferably the wire arms define an angle of about forty-five degrees.

In a key aspect of the invention, a second blade is attached to the eye loop to impart a vibrating motion to the lure that is caused by water pressure pushing the second blade rapidly back and forth. Preferably the second blade is a six sided, elongated piece of flat rigid material such as plastic or stainless steel.

The eye loop is attached directly to the second blade, and preferably extends through a hole or opening in the second blade near its bottom edge. Preferably the eye loop is a double coiled loop and defines a plane that is perpendicular to the plane defined by the wire arms.

The fishing line may be attached to a snap affixed to the vibrating blade.

### THE DRAWINGS

FIG. 1 is a perspective view of a fishing lure according to the present invention.

FIG. 2 is a close up perspective view of a portion of the fishing lure of FIG. 1.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

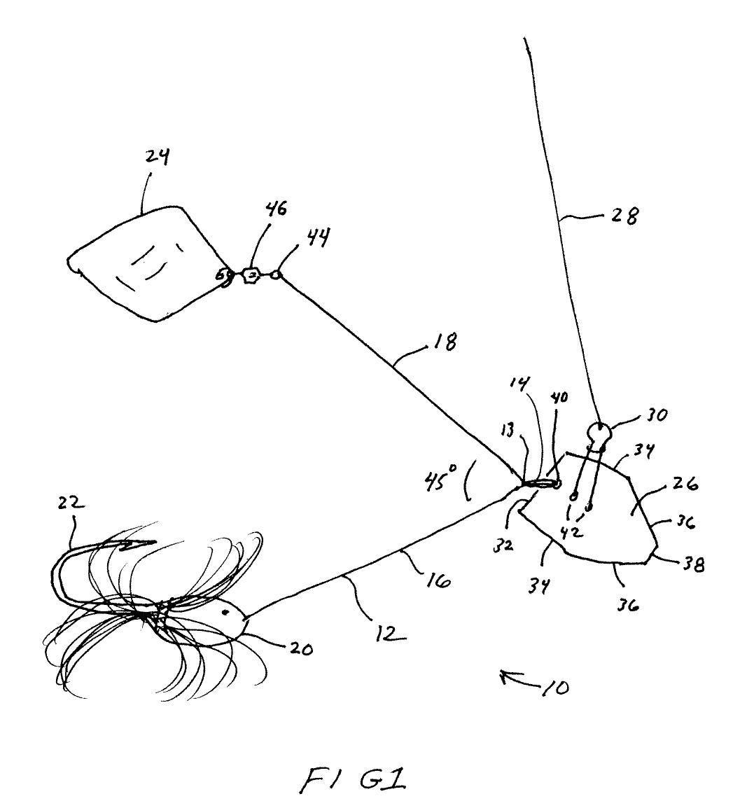

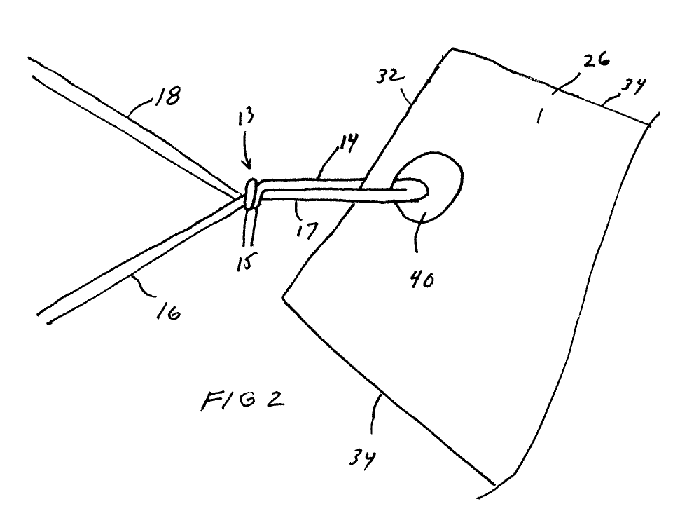

Turning to the drawings, there is shown in FIGS. 1 and 2 one embodiment of the present invention, a novel fishing lure 10 combining the advantages of a chatter bait lure and a spinner bait lure. The lure 10 comprises a substantially V-shaped wire 12 having an eye loop 14 at its apex and first and second arms 16, 18 extending from the eye loop 14. A jig head 20 having a fishhook 22 projecting therefrom is attached to the distal end of one arm 16. A spinner blade 24 is attached to the distal end of the second arm 18.

In an important aspect of the invention, a second blade 26 is attached to the eye loop 14 to impart a vibrating motion to the lure 10 that is caused by water pressure pushing the second blade 26 rapidly back and forth. The second blade 26 causes the body 20 and hook 22 to vibrate but has minimal affect on the line 28 itself.

The second blade 26 may be any style or shape and be made from any material as long as it imparts vibrational movement to the lure 10. Preferably the second blade 26 is a six sided, symmetrical, elongated piece of flat rigid material such as plastic or stainless steel. The sides consist of a bottom edge 32, two first side edges 34 diverging outwardly from the bottom edge 32 and having equal lengths, two second side edges 36 converging inwardly from the first side edges 34 and having equal lengths, and a top edge 38 connecting the second side edges 36 and having a length shorter than the bottom edge 32. The second blade 26 may be any color, may or may not be reflective, and may or may not bear markings.

The eye loop 14 comprises a neck portion 13 and a loop portion 17. The second blade 26 is attached to the loop portion 17. Preferably, the loop portion 17 extends through an opening 40 in the second blade 26 near its bottom edge 32. The loop portion 17 may comprise a single loop, as shown in FIG. 2, or multiple loops for added strength. The preferred number of loops is two.

At the neck portion 13, the eye loop 14 wraps around itself at least once, and preferably twice, forming two complete wraps 15, to prevent the second blade 26 from sliding down the wire 12 during casting and retrieval.

The wire arms 16, 18 may be any shape but preferably are straight. They can define any angle, but preferably they define an angle of less than ninety degrees and optimally about forty-five degrees. Together the wire arms 16, 18 define a plane.

The eye loop 14 also defines a plane, one that can be oriented in any suitable manner with respect to the plane defined by the wire arms 16, 18, including parallel thereto. Preferably the eye loop 14 defines a plane that is perpendicular to the plane defined by the wire arms 16, 18 and wherein the “eye loop” plane bisects the angle defined by the arms 16, 18, as shown in FIG. 2. The wire arms 16, 18 may be thought of as defining a vertical plane whereas the eye loop 14 defines a horizontal plane.

The fishing line 28 preferably is attached to the second blade 26. More particularly, the fishing line 28 is attached to a snap 30 which itself loops through second and third openings 42 in the second blade 26. The second and third openings 42 preferably are located near the bottom edge 32 of the second blade 26 between and preferably equidistant the first side edges 34.

The second arm 18 terminates in an eyelet 44. A swivel 46 is attached to the eyelet 44 and the first spinner blade 24 is attached to the end of the swivel 46 opposite the eyelet 44.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A fishing lure comprising:
a V-shaped wire having an eye loop at its apex and two arms extending from the eye loop, each arm having a distal end located away from the apex;
a jig head and hook assembly attached to the distal end of one arm;
a first blade rotatably attached to the distal end of the other arm;
a second blade attached to the eye loop for imparting vibrational movement to the lure; and
means for attaching a fishing line to the second blade.

2. The fishing lure of claim 1 wherein the eye loop defines a plane perpendicular to a plane defined by the arms.

3. The fishing lure of claim 2 wherein the eye loop comprises a neck portion and a loop portion and wherein, at its neck portion, the eye loop wraps around itself twice.

4. The fishing lure of claim 3 wherein the loop portion comprises multiple loops.

5. The fishing lure of claim 1 wherein the eye loop extends through an opening in the second blade.

6. The fishing lure of claim 5 wherein the second blade has second and third openings and the attaching means comprises a snap that extends through the second and third openings.

7. The fishing lure of claim 1 wherein the second blade is a six sided elongated piece of flat rigid material.

8. The fishing lure of claim 7 wherein the sides consist of a bottom edge, two first side edges diverging outwardly from the bottom edge and having equal lengths, two second side edges converging inwardly from the first side edges and having equal lengths, and a top edge connecting the second side edges and having a length shorter than the bottom edge.

9. The fishing lure of claim 1 wherein the wire arms are straight and define an angle therebetween.

10. The fishing lure of claim 9 wherein the wire arms define an angle of about forty-five degrees.

11. The fishing lure of claim 9 wherein the wire arms define a plane, the eye loop defines a plane, and the plane defined by the eye loop is perpendicular to the plane defined by the wire arms.

12. The fishing lure of claim 11 wherein the plane defined by the eye loop bisects the angle defined by the arms.

13. The fishing lure of claim 1 wherein the fishing line is attached to a snap which loops through openings in the second blade.
